(19) United States
(12) Patent Application Publication
(10) Pub. No.: US 2025/0209554 A1
(43) Pub. Date: Jun. 26, 2025

(54) INFORMATION PROCESSING APPARATUS, INFORMATION PROCESSING METHOD, AND STORAGE MEDIUM

(71) Applicant: NEC Corporation, Minato-ku, Tokyo (JP)

(72) Inventors: Ryo AIDA, Tokyo (JP); Mizuho Toyama, Tokyo (JP)

(73) Assignee: NEC Corporation, Minato-ku, Tokyo (JP)

(21) Appl. No.: 18/849,108

(22) PCT Filed: Mar. 29, 2022
(86) PCT No.: PCT/JP2022/015438

§ 371 Date: Sep. 20, 2024

(51) Int. Cl. G06Q 50/18; G06F 40/40; G06N 20/00

(52) U.S. Cl. CPC G06Q 50/18; G06F 40/40; G06N 20/00

(57) ABSTRACT

In order to carry out more suitable inference related to a target document, an information processing apparatus (1) includes: an acquisition section (11) that acquires a target document which is at least a part of a target draft written contract; an inference section (12) that carries out inference related to the target document, with use of an inference model trained by using a written contract template of a target company and a concluded written contract related to at least one of the target company and another company which differs from the target company; and a generation section (13) that generates output information obtained with reference to an inference result obtained by the inference section (12).

### TECHNICAL FIELD

The present invention relates to an information processing apparatus, an information processing method, and an information processing program.

### BACKGROUND ART

Artificial intelligence (AI) for assisting preparation of written contracts has been proposed. For example, Patent Literature 1 discloses, as a document review assisting method with which a person in charge of contracts who is unpracticed and who is poor in knowledge can easily review a written contract, the method including: acquiring various classification types (industry type, written contract type, article type, etc.) of the written contract with use of a classifier obtained by machine learning; evaluating the written contract for each of articles on the basis of the various classification types that have been acquired: and generating a screen data including an evaluation result.

### CITATION LIST

### Patent Literature

### Patent Literature 1

Japanese Patent Application Publication Tokukai No. 2020-119087

### SUMMARY OF INVENTION

### Technical Problem

However, a method of description, priority of rules, etc. in written contracts differ from one company to another. For this reason, in a technique disclosed in Patent Literature 1, it has been difficult to perform written contract review or the like that is suitable to each of target documents.

An example aspect of the present invention is attained in view of the above problem. An example object of the present invention is to provide a technique that makes it possible to carry out more suitable inference related to a target document.

### Solution to Problem

An information processing apparatus in accordance with an aspect of the present invention includes: an acquisition means that acquires a target document which is at least a part of a target draft written contract; an inference means that carries out inference related to the target document, with use of an inference model trained by using a written contract template of a target company and a concluded written contract related to at least one of the target company and another company which differs from the target company; and a generation means that generates output information obtained with reference to an inference result obtained by the inference means.

An information processing apparatus in accordance with an aspect of the present invention includes: an acquisition means that acquires a written contract template of a target company and a concluded written contract related to at least one of the target company and another company which differs from the target company; and a training means that trains, with reference to information acquired by the acquisition means, an inference model that carries out inference on a target document.

An information processing method in accordance with an aspect of the present invention includes: acquiring, by at least one processor, a target document which is at least a part of a target draft written contract; carrying out, by the at least one processor, inference related to the target document, with use of an inference model trained by using a written contract template of a target company and a concluded written contract related to at least one of the target company and another company which differs from the target company; and generating, by the at least one processor, output information obtained with reference to an inference result obtained by the inference.

An information processing method in accordance with an aspect of the present invention includes: acquiring, by at least one processor, a written contract template of a target company and a concluded written contract related to at least one of the target company and another company which differs from the target company; and training, by the at least one processor, with reference to the written contract template and the concluded written contract, an inference model that carries out inference on a target document.

An information processing program in accordance with an aspect of the present invention causes a computer to carry out: an acquisition process for acquiring a target document which is at least a part of a target draft written contract; an inference process for carrying out inference related to the target document, with use of an inference model trained by using a written contract template of a target company and a concluded written contract related to at least one of the target company and another company which differs from the target company; and a generation process for generating output information obtained with reference to an inference result obtained by the inference process.

An information processing program in accordance with an aspect of the present invention causes a computer to carry out: an acquisition process for acquiring a written contract template of a target company and a concluded written contract related to at least one of the target company and another company which differs from the target company; and a training process for training, with reference to information acquired in the acquisition process, an inference model that carries out inference on a target document.

### Advantageous Effects of Invention

An example aspect of the present invention makes it possible to carry out more suitable inference related to a target document.

### BRIEF DESCRIPTION OF DRAWINGS

FIG. 1 is a block diagram illustrating a configuration of an information processing apparatus in accordance with a first example embodiment.

FIG. 2 is a flowchart showing a flow of an information processing method in accordance with the first example embodiment.

FIG. 3 is a block diagram illustrating a configuration of another information processing apparatus in accordance with the first example embodiment.

FIG. 4 is a flowchart showing a flow of another information processing method in accordance with the first example embodiment.

FIG. 5 is a diagram illustrating an overview of an information processing apparatus in accordance with a second example embodiment.

FIG. 6 is a block diagram illustrating a configuration of the information processing apparatus in accordance with the second example embodiment.

FIG. 7 is a diagram illustrating a configuration example of an inference model.

FIG. 8 is a diagram illustrating specific examples of condition determination of a master model and an individual model.

FIG. 9 is a diagram illustrating a specific example of output information.

FIG. 10 is a diagram illustrating another specific example of output information.

FIG. 11 is a block diagram illustrating a configuration of an information processing apparatus in accordance with a third example embodiment.

FIG. 12 is a view illustrating an example of a computer that executes instructions of a program which is software for realizing functions of apparatuses in accordance with example embodiments of the present invention.

### DESCRIPTION OF EMBODIMENTS

### First Example Embodiment

A first example embodiment of the present invention will be described in detail with reference to the drawings. The present example embodiment is a basic form of example embodiments described later.

### Configuration of Information Processing Apparatus 1

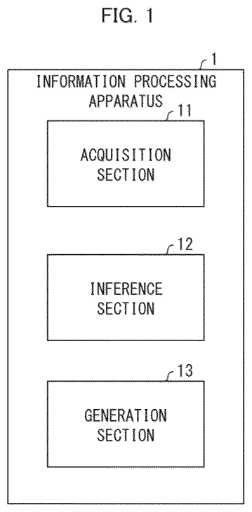

The following description will discuss a configuration of an information processing apparatus 1 in accordance with the present example embodiment with reference to FIG. 1. FIG. 1 is a block diagram illustrating the configuration of the information processing apparatus 1. The information processing apparatus 1 includes an acquisition section 11, an inference section 12, and a generation section 13.

### Acquisition section 11

The acquisition section 11 acquires a target document that is at least a part of a target draft written contract. The target draft written contract here refers to a draft written contract/agreement that is a target of inference carried out by the information processing apparatus 1, and is for example, a draft written contract/agreement prepared in a company to which a user belongs. The draft written contract includes, for example, the content of a contract for each of one or more articles/clauses/sections. The target draft written contract is, for example, a draft document that indicates the content of a confidentiality agreement. However, the draft written contract is not limited to such an example, and can be another draft written contract. The target document may be the entirety of the target draft written contract or may be a part of the target draft written contract (for example, a document having some of a plurality of articles which are contained in the draft written contract).

### Inference Section 12 and Inference Model

The inference section 12 carries out inference related to the target document with use of an inference model. The inference model here refers to a model that has been trained by using a written contract template of a target company and a concluded written contract that is related to the target company and/or another company which differs from the target company. The target company refers to a company that is to agree on a contract, and is, for example, a company to which a user belongs. The concluded written contract refers to a document that indicates the content of a contract which was concluded in the past, and is, for example, a document of a confidentiality agreement which was concluded between the target company and another company. Note however that the concluded written contract is not limited to the above-described example, but may be another written contract that was concluded in the past. The concluded written contract which is to be used for training the inference model may be a concluded written contract which a company that is to agree on the contract of the target draft written contract concluded in the past or a concluded written contract which another company concluded.

The inference model refers to a model for carrying out inference related to the target document. The inference model includes one or more models. The inference model may include a model that is generated through supervised learning using training data or alternatively a model that is generated through unsupervised learning. Examples of the inference model include a discrimination model for discriminating a class of input data or a generative model for generating artificial data. Examples of the generative model include an autoencoder or a generative adversarial network (GAN). Note however that the inference model is not limited to the above-described examples, but may be another model. A method for machine learning of the inference model is not limited. For example, a decision tree-based method, a method using linear regression, or a method using a neural network may be used. Alternatively, two or more of these methods may be used.

Input to the inference model includes the target document that has been acquired by the acquisition section 11. Note, however, that the input to the inference model may include other information. For example, the input to the inference model may include at least one selected from the group consisting of:
a written contract template of the target company;
a concluded written contract that is related to the target company and/or another company which differs from the target company;
information on past negotiation between the target company and the another company;
the number of written contracts that were concluded in the past between the target company and the another company;
a history of negotiation between the target company and the another company;
a difference between a concluded written contract and a written contract template of the target company;
a history of a change(s) in the written contract in the past between the target company and the another company; and
information on past negotiation between the target company and one or more companies that are included in an industry to which the another company belongs.

Output of the inference model includes information on inference of the target document. The information on inference of the target document includes, for example, at least one selected from the group consisting of a proposed correction of the target document, a probability of conclusion of an article included in the target document, and a negotiation scenario regarding an article included in the target document.

### Generation Section 13

The generation section 13 generates output information that is obtained with reference to an inference result obtained by the inference section 12. Here, the output information includes, for example, at least one selected from the group consisting of information that indicates a proposed correction of the target document, information that indicates a probability of conclusion of an article included in the target document, and information that indicates a negotiation scenario regarding an article included in the target document.

### Example Advantage of Information Processing Apparatus 1

As described above, the information processing apparatus 1 in accordance with the present example embodiment employs the configuration of including: an acquisition section 11 that acquires a target document which is at least a part of a target draft written contract; an inference section 12 that carries out inference related to the target document, with use of an inference model trained by using a written contract template of a target company and a concluded written contract related to at least one of the target company and another company which differs from the target company; and a generation section 13 that generates output information obtained with reference to an inference result obtained by the inference section 12. By using an inference model trained with use of a written contract template of a target company and a concluded written contract of the target company and/or another company that differs from the target company, the information processing apparatus 1 in accordance with the present example embodiment can yield an example advantage of making it possible to carry out more suitable inference related to the target document.

### Information Processing Program

The functions of the information processing apparatus 1 described earlier can also be realized by a program. An information processing program in accordance with the present example embodiment causes a computer to carry out: an acquisition process for acquiring a target document which is at least a part of a target draft written contract; an inference process for carrying out inference related to the target document, with use of an inference model trained by using a written contract template of a target company and a concluded written contract related to at least one of the target company and another company which differs from the target company; and a generation process for generating output information obtained with reference to an inference result obtained by the inference process.

### Flow of Information Processing Method S1

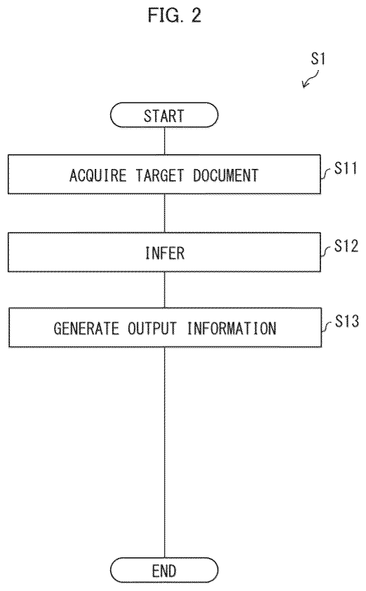

The following description will discuss a flow of an information processing method S1 in accordance with the present example embodiment with reference to FIG. 2. FIG. 2 is a flowchart showing the flow of the information processing method S1. Steps of the information processing method S1 may be carried out by a processor of the information processing apparatus 1 or by a processor of another apparatus. Alternatively, the steps may be carried out by processors provided in respective different apparatuses.

In step S11, at least one processor acquires a target document which is at least a part of a target draft written contract. In step S12, the at least one processor carries out inference related to the target document, with use of an inference model trained by using a written contract template of a target company and a concluded written contract related to at least one of the target company and another company which differs from the target company. In step S13, the at least one processor generates output information obtained with reference to an inference result obtained by the inference.

### Example Advantage of Information Processing Method S1

As described above, the information processing method S1 in accordance with the present example embodiment employs a configuration including: acquiring, by at least one processor, a target document which is at least a part of a target draft written contract; carrying out, by the at least one processor, inference related to the target document, with use of an inference model trained by using a written contract template of a target company and a concluded written contract related to at least one of the target company and another company which differs from the target company; and generating, by the at least one processor, output information obtained with reference to an inference result obtained by the inference. Thus, the information processing method S1 in accordance with the present example embodiment can yield an example advantage of making it possible to carry out more suitable inference related to the target document.

### Configuration of Information Processing Apparatus 2

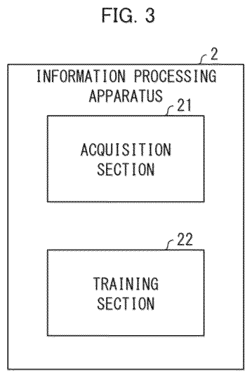

The following description will discuss a configuration of an information processing apparatus 2 in accordance with the present example embodiment with reference to FIG. 3. FIG. 3 is a block diagram n illustrating the configuration of the information processing apparatus 2. The information processing apparatus 2 includes an acquisition section 21 and a training section 22.

### Acquisition Section 21

The acquisition section 21 acquires a written contract template of a target company and a concluded written contract related to at least one of the target company and another company which differs from the target company.

### Training Section 22

The training section 22 trains an inference model that carries out inference on a target document, with reference to information that has been acquired by the acquisition section 21. The inference model includes one or more models. The inference model may include a model that is generated through supervised learning using training data or alternatively a model that is generated through unsupervised learning. Examples of the inference model include a discrimination model for discriminating a class of input data or a generative model for generating artificial data. Examples of the generative model include generative models such as an autoencoder or a generative adversarial network. The inference model is not limited to the above examples, and can be another model. A method for machine learning of the inference model is not limited. For example, a decision tree-based method, a method using linear regression, or a method using a neural network may be used. Alternatively, two or more of these methods may be used.

### Example Advantage of Information Processing Apparatus 2

As described above, an information processing apparatus 2 in accordance with the present example embodiment employs a configuration including: an acquisition section 21 that acquires a written contract template of a target company and a concluded written contract related to at least one of the target company and another company which differs from the target company; and a training section 22 that trains, with reference to information acquired by the acquisition section 21, an inference model that carries out inference on a target document. Thus, the information processing apparatus 2 in accordance with the present example embodiment can yield an example advantage of making it possible to generate an inference model for carrying out more suitable inference related to the target document.

### Information Processing Program

Functions of the information processing apparatus 2 described above can also be realized by a program. An information processing program in accordance with the present example embodiment causes a computer to carry out: an acquisition process for acquiring a written contract template of a target company and a concluded written contract related to at least one of the target company and another company which differs from the target company; and a training process for training, with reference to information acquired in the acquisition process, an inference model that carries out inference on a target document.

### Flow of Information Processing Method S2

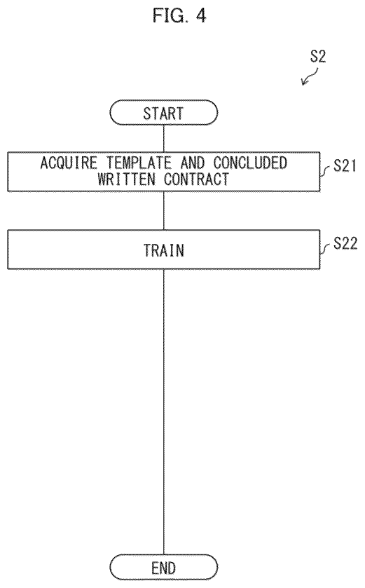

The following description will discuss a flow of an information processing method S2 in accordance with the present example embodiment with reference to FIG. 4. FIG. 4 is a flowchart illustrating the flow of the information processing method S2. Steps of the information processing method S2 may be carried out by a processor of the information processing apparatus 2 or by a processor of another apparatus. Alternatively, the steps may be carried out by processors provided in respective different apparatuses.

In step S21, at least one processor acquires a written contract template of a target company and a concluded written contract related to at least one of the target company and another company which differs from the target company. In step S22, the at least one processor trains, with reference to the written contract template and the concluded written contract, an inference model that carries out inference on a target document.

### Example Advantage of Information Processing Method S2

As described above, the information processing method S2 in accordance with the present example embodiment employs a configuration including: acquiring, by at least one processor, a written contract template of a target company and a concluded written contract related to at least one of the target company and another company which differs from the target company; and training, by the at least one processor, with reference to the written contract template and the concluded written contract, an inference model that carries out inference on a target document. Thus, the information processing method S2 in accordance with the present example embodiment can yield an example advantage of making it possible to generate an inference model for carrying out more suitable inference related to the target document.

### Second Example Embodiment

The following description will discuss a second example embodiment of the present invention, with reference to drawings. Note that members having functions identical to those of the respective members described in the first example embodiment are given respective identical reference numerals, and a description of those members will not be repeated.

### Overview of Information Processing Apparatus 1A

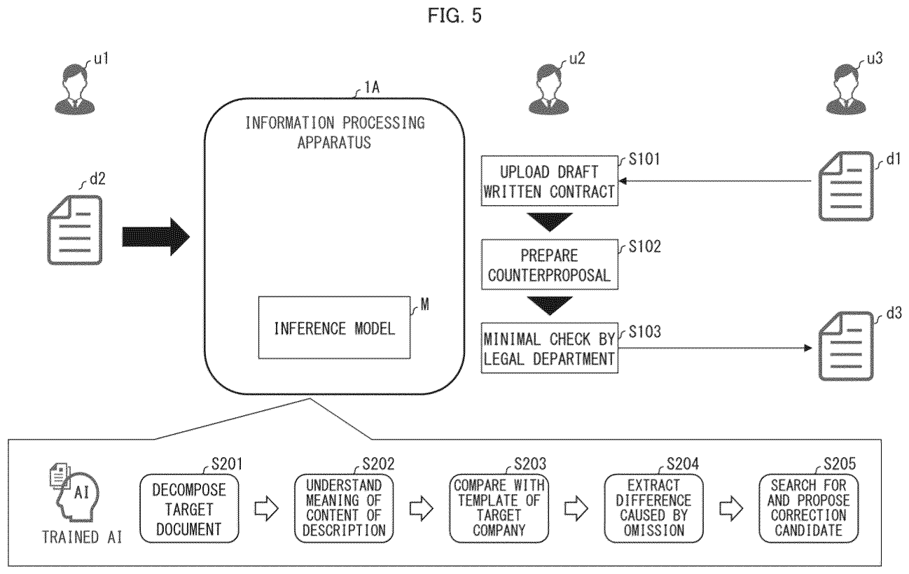

An information processing apparatus 1A provides a service for assisting review of a draft written contract. FIG. 5 is a diagram schematically illustrating an overview of the information processing apparatus 1A in accordance with a second example embodiment. In FIG. 5, a user u1 refers to a user who carries out initial setting of the information processing apparatus 1A, and is, for example, a user who belongs to a legal department of a target company. For example, the user u1 registers, in the information processing apparatus 1A, training data d2 that is to be used for training the inference model M. A user u3 is a user who provides a draft written contract to be reviewed, and is, for example, a person in charge in a customer company. A user u2 is a user who carries out check etc. of the draft written contract on the basis of output information that is outputted by the information processing apparatus 1A, and is, for example, a person in charge in a business division.

In the example of FIG. 5, first, the user u1 registers, as an initial setting, the training data d2 in the information processing apparatus 1A. The training data d2 includes a written contract template of the target company, a concluded written contract in the past, and the like. The information processing apparatus 1A trains the inference model M with use of the training data d2 thus registered. Further, the user u3 provides a draft written contract that includes the target document d1. The draft written contract that is provided by user u3 may be a draft written contract that is prepared by using a template of the target company or a draft written contract that is prepared by using a template of a partner company of that contract.

Moreover, through processes in steps S101 to S103 in FIG. 5, the draft written contract is reviewed. First, in step S101 of FIG. 5, the user u2 or the user u3 uploads the draft written contract to the information processing apparatus 1A. Regarding uploading of the draft written contract, there may be (a) a case in which a user directly uploads a pdf file, a file in word format, or the like to a system or (b) a case in which a service provider uploads the file after the file is sent by mail to the service provider. In step S102, the information processing apparatus 1A carries out inference on the target document d1 with use of the inference model M, and creates a counterproposal. In step S103, the user u1 who belongs to the legal department carries out minimal check on the counterproposal and presents a counterproposal d3 to the user u3. Note, however, that the check at the legal department is not essential, and step S103 may be omitted.

A process for creating the counterproposal in step S102 includes, for example, processes in steps S201 to S205 in FIG. 5. In steps S201 to S205, the information processing apparatus 1A carries out: decomposition of the target document d1 with use of the inference model M; semantic understanding of description content of the target document d1; comparison of the target document d1 with the template of the target company; extraction of a difference such as an omission; search for and proposition of a correction candidate; and the like. Details of these processes will be described later.

### Configuration of Information Processing Apparatus 1A

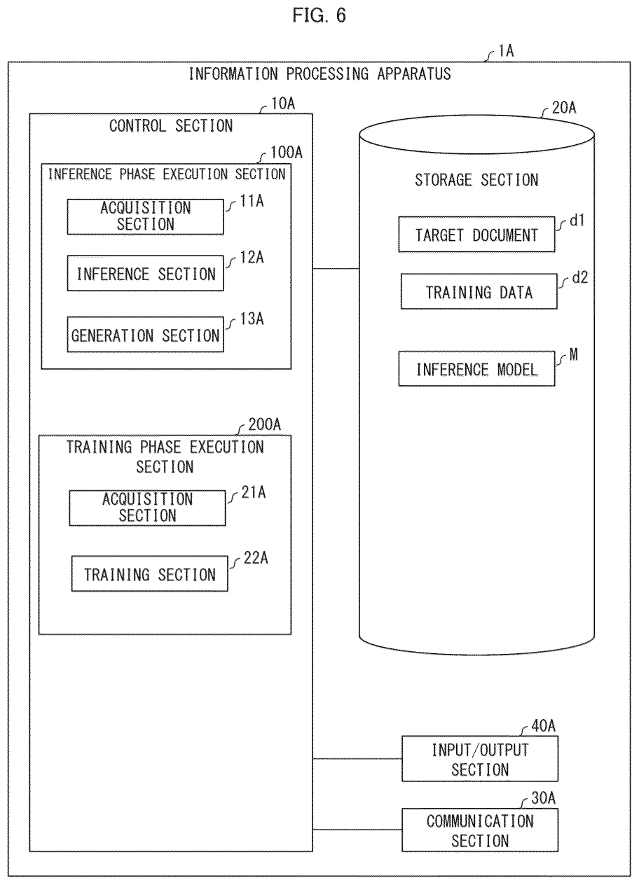

FIG. 6 is a block diagram illustrating the configuration of the information processing apparatus 1A. The information processing apparatus 1A includes a control section 10A, a storage section 20A, a communication section 30A, and an input/output section 40A.

### Communication Section 30A

The communication section 30A communicates with an apparatus external to the information processing apparatus 1A via a communication line. A specific configuration of the communication line is not limited to the present example embodiment. Examples of the communication line include a wireless local area network (LAN), a wired LAN, a wide area network (WAN), a public network, a mobile data communication network, and a combination thereof. The communication section 30A transmits, to another apparatus, data supplied from the control section 10A, and supplies, to the control section 10A, data received from another apparatus.

### Input/Output Section 40A

To the input/output section 40A, an input/output apparatus(es) such as a keyboard, a mouse, a display, a printer, a touch panel, a camera, and/or an image reading apparatus is/are connected. The input/output section 40A receives, from an input apparatus(es) connected thereto, input of various pieces of information to the information processing apparatus 1A. Further, the input/output section 40A outputs, to an output apparatus(es) connected thereto, various pieces of information under control by the control section 10A. Examples of the input/output section 40A include an interface such as a universal serial bus (USB). As the target document d1, for example, image data that indicates an image obtained by capturing an image of a document with a camera may be inputted. In this case, the control section 10A may carry out conversion of the image data into text by carrying out, on the image data, a process of an optical character reader (OCR) or the like.

### Control Section 10A

The control section 10A includes an inference phase execution section 100A and a training phase execution section 200A. The inference phase execution section 100A executes an inference phase using the inference model M. The training phase execution section 200A executes a training phase of the inference model M. The inference phase execution section 100A includes an acquisition section 11A, an inference section 12A, and a generation section 13A. The training phase execution section 200A includes an acquisition section 21A and a training section 22A.

### Acquisition Section 11A

The acquisition section 11A acquires, as the target document d1, at least a part of a draft written contract between the target company and another company. The target document d1 is at least a part of a draft written contract that is a target of inference to be carried out by the information processing apparatus 1A, and includes the content of a contract for each of one or more articles. The target document d1 is, for example, at least a part of a draft confidentiality agreement that indicates the content of a confidentiality agreement between the target company and the another company. The target company is a company to which a user belongs. The target document d1 may be prepared according to a template of the target company or may be prepared according to a template of the partner company of the contract. The target document d1 includes, for example, one or more issues such as “preliminary sentence”, “purpose”, “definition of confidential information”, “exception of confidential information”, “confidentiality”, “scope of disclosure”, “copy”, “damages”, “term”, “consultation”, and “end of operative provisions”.

The acquisition section 11A may acquire, for example, a target document d1 that is to be received from another apparatus connected via the communication section 30A. Alternatively, the acquisition section 11A may acquire a target document d1 that is inputted via an input apparatus connected to the input/output section 40A. Alternatively, the acquisition section 11A may read the target document d1 from the storage section 20A or another external storage apparatus, and thus acquire the target document d1.

The acquisition section 11A may carry out processing for dividing a draft written contract between the target company and another company, and may acquire, as the target document d1, at least some of articles of the draft written contract thus divided. In this case, the acquisition section 11A may perform, for example, layout analysis, morphological analysis, syntactic analysis, and the like of the draft written contract, and divide, into each article, text contained in the draft written contract. Note however that the acquisition section 11A may divide the draft written contract by another method instead of dividing the draft written contract into each article. For example, the draft written contract may be divided into each article sentence or each clause.

### Inference Section 12A

The inference section 12A carries out inference on the target document d1 with use of the inference model M. Details of processing that the inference section 12A executes will be described later.

### Generation Section 13A

The generation section 13A generates output information that is obtained with reference to an inference result obtained by the inference section 12A. The generation section 13A outputs the output information generated. The generation section 13A may, for example, transmit the output information by sending the output information to another apparatus connected via the communication section 30A or may output the output information to an output apparatus connected to the input/output section 40A. Here, examples of the output apparatus include a display, a printer, a projector, and a speaker. The generation section 13A may output the output information by writing the output information in the storage section 20A or an external storage apparatus.

### Acquisition Section 21A

The acquisition section 21A acquires the training data d2 that is to be used for training the inference model M. The acquisition section 21A may acquire, for example, training data d2 that is received from another apparatus connected via the communication section 30A, or may acquire training data d2 that is inputted by an input apparatus connected to the input/output section 40A. Alternatively, the acquisition section 11A may read the training data d2 from the storage section 20A or another external storage apparatus and thus acquire the training data d2.

### Training Section 22A

The training section 22A trains, with reference to the training data d2 that has been acquired by the acquisition section 21A, the inference model M for carrying out inference on a target document. The inference model M trained by the training section 22A is used in an inference process of the inference section 12A.

### Storage Section 20A

The storage section 20A stores the target document d1 that has been acquired by the acquisition section 11A, and also stores the training data d2 that has been acquired by the acquisition section 21A. Further, the storage section 20A stores the inference model M. Note that the wording “the storage section 20A stores the inference model M” means that the storage section 20A stores parameters that define the inference model M.

### Inference Model M

The inference model M is for carrying out inference related to the target document d1. The inference model M includes one or more models. The inference model M may include a model that is generated through supervised learning using training data or alternatively a model that is generated through unsupervised learning. Examples of the inference model M include a discrimination model for discriminating a class of input data or a generative model for generating artificial data. Examples of the generative model include generative models such as an autoencoder or a generative adversarial network. The inference model is not limited to the above examples, and can be another model. A method for machine learning of the inference model is not limited. For example, a decision tree-based method, a method using linear regression, or a method using a neural network may be used. Alternatively, two or more of these methods may be used.

### Input of Inference Model M

Input of the inference model M includes the target document d1. Note however that the input to the inference model M may include data other than the target document d1. The input to the inference model M may include, for example, at least one selected from the group consisting of (i) to (v) below.
(i) A written contract template of the target company
(ii) A concluded written contract that is related to the target company and/or another company which differs from the target company
(iii) Information on past negotiation between the target company and the another company
(iv) Information on past negotiation between the target company and one or more companies that are included in an industry to which the another company belongs
(v) At least a part of a draft written contract that was not concluded in the past between the target company and the another company

Here, the information on the past negotiation in the above-described (iii) includes, for example, at least one selected from the group consisting of the following.
The number of concluded contracts achieved for each partner and/or for each article
A history of negotiation for each partner and/or for each article
A difference between a written contract template of the target company and a concluded written contract
A history of a change(s) in a written contract in the past between the target company and the another company;
Timing of conclusion of a contract for the partner and/or for each article

Here, the history of the negotiation includes, for example, the number of negotiations and/or a time taken to reach the conclusion of that contract. Further, the difference between the written contract template of the target company and the concluded written contract includes, for example, a difference in conditions between the written contract template of the target company and a concluded result.

The information of the above-described (iv) includes, for example, at least one selected from the group consisting of the following.
The number of concluded contracts achieved for each industry to which a partner belongs
The number of negotiations and/or a time taken to reach the conclusion for each article and/or for each industry to which a partner belongs
A difference in conditions between a template of the target company and a concluded result for each industry to which a partner belongs and/or for each article

### Output of Inference Model M

Output of the inference model M includes, for example, at least one of the following (a) to (e).
(a) Information on correction of the target document d1
(b) Probability of conclusion for each article of the draft written contract or the probability of conclusion of the entirety of the draft written contract
(c) A negotiation scenario
(d) A degree of recommendation of an article sentence and/or a condition, and a degree of priority as a correction candidate of the article sentence and/or the condition
(e) An article that may be subject to negotiation

Here, the above (a) information on correction of the target document d1 includes, for example, information that presents an indication on an omission of an article or an issue, a correction of an error, or a proposal of stylistic conversion. The information that presents an indication on an omission of an article or an issue is, for example, a checklist that indicates whether the target document d1 includes a necessary article(s) or a necessary issue(s). The information that presents a correction of an error indicates content of the correction of the error included in the target document d1. The information that presents the proposal of the stylistic conversion includes, for example, a proposal to convert “say about” to “refer to . . . ”.

Further, (a) the information on the correction of the target document d1 may be information that indicates a correction candidate of the target document d1. Meanwhile, (c) the negotiation scenario is a policy on negotiation with a partner company that is to agree on the contract, and includes, for example, a secondary proposal or a tertiary proposal each of which takes into account a reaction of the partner company.

In a case where the inference model M is a discrimination model, for example, the inference model M includes convolution layers, pooling layers, and connection layers. In the convolution layers, input data is subjected to convolution of information by filtering, and resultant data that has undergone the convolution is subjected to a pooling process in the pooling layers. The data that has undergone the pooling process is processed in the connection layers. As a result, the data is converted into output data of the inference model M, for example, the probability of conclusion of the draft written contract, and then outputted. In a case where the inference model M is a generative model, for example, the input data is inputted to the inference model M, so that the inference model M outputs a corrected document (counterproposal) of the target document d1.

### Training Data d2 for Inference Model M

The training data d2 of the inference model M includes at least the following (i) and (ii).
(i) A written contract template of the target company
(ii) A concluded written contract that is related to the target company and/or another company which differs from the target company

Here, (ii) the concluded written contract may be a written contract that is prepared by using a template of the target company or a written contract that is prepared by using a template of another company that differs from the target company.

Further, the training data d2 includes at least one selected from the group consisting of (iii) to (v). The training data d2 may also include data other than the following (iii) to (v).
(iii) Information on past negotiation between the target company and the another company
(iv) Information on past negotiation between the target company and one or more companies that are included in an industry to which the another company belongs
(v) At least a part of a draft written contract that was not concluded in the past between the target company and the another company

Here, in a case where the training data includes the above-described (iii), the inference model M is reworded as a model trained with reference to the information on past negotiation between the target company and the another company. Here, the information on past negotiation includes, for example, at least one selected from the group consisting of the following.
The number of concluded contracts achieved for each partner and/or for each article
A history of negotiation for each partner and/or for each article
A difference between a written contract template of the target company and a concluded written contract
A history of a change(s) in a written contract in the past between the target company and the another company
Timing of conclusion of a contract for each partner and/or for each article
User's reaction to a system

Here, the user's reaction to the system includes, for example, a user's reaction to a proposed written contract correction provided by the information processing apparatus 1A (for example, a proposed correction is ignored, a candidate AA is selected, or a correction that is not included in the candidate is made).

Further, in a case where the training data d2 includes the number of concluded contracts achieved, the inference model M is reworded as a model trained at least with reference to the number of written contracts that were concluded in the past between the target company and the another company.

Further, in a case where the training data d2 includes the history of negotiation, the inference model M is reworded as a model trained at least with reference to the history of negotiation between the target company and the another company. Here, the history of the negotiation includes, for example, the number of negotiations and/or a time taken to reach the conclusion of that contract.

Further, in a case where the training data d2 includes a difference between a written contract template of the target company and a concluded written contract, the inference model M is reworded as a model trained at least with reference to the difference between the written contract template of the target company and the concluded written contract. Here, the difference between the written contract template of the target company and the concluded written contract includes, for example, a difference in conditions between the written contract template of the target company and a concluded result.

Further, in a case where the training data d2 includes the history of a change(s) in the written contract in the past, the inference model M is reworded as a model trained at least with reference to the history of the change(s) in the written contract in the past between the target company and the another company.

Further, in a case where the training data d2 includes the above-described (iv), the inference model M is reworded as a model trained at least with reference to the information on the past negotiation between the target company and the one or more companies which are included in an industry to which the another company belongs. Here, the information of the above (iv) includes, for example, at least one selected from the group consisting of the following.
The number of concluded contracts achieved for each industry to which a partner belongs
The number of negotiations and/or a time taken to reach the conclusion for each article and/or for each industry to which a partner belongs
A difference in conditions between a template of the target company and a concluded result for each industry to which a partner belongs and/or for each article

Further, in a case where the training data d2 includes the above-described (v), the inference model M is reworded as a model trained at least with reference to the draft written contract that was not concluded in the past between the target company and the another company.

In addition, in a case where the inference model M is generated through supervised learning, the training data d2 may include a label or the like that indicates whether a contract was concluded.

### Specific Examples of Inference Process

The following description will discuss Examples 1 to 3 as specific examples of the inference process carried out by the inference section 12A and the output information generated by the generation section 13A.

### Example 1

The inference process carried out by the inference section 12A includes, for example, inference related to correction of a target document d1. Here, the inference related to correction includes, for example, a process of the following inference or the like: ‘in a case where a wording “AAA” is corrected to read “BBB”, the probability of conclusion will improve by X %’ or the like. In this case, the inference model M is, for example, an inference model that uses the target document d1 as input and outputs information that indicates corrected content of the target document d1. The inference model M is, for example, a generative model such as an autoencoder or an adversarial generation network. The generation section 13A generates the output information that includes a proposal related to the correction of the target document d1, on the basis of output of the inference model M.

### Example 2

Further, the inference process carried out by the inference section 12A includes, for example, inference related to the probability of concluding a contract with the another company. In this case, the inference model M is, for example, a discrimination model that uses the target document d1 as input and that outputs the probability of concluding the target document d1. In this case, the inference model M is, for example, generated through supervised machine learning using training data that includes: a set of a concluded written contract in the past and a label indicating that this written contract was concluded; and a set of a draft written contract that was not concluded in the past and a label indicating that this draft written contract was not concluded. In this case, the generation section 13A generates output information that includes the probability of concluding the contract with the another company on the basis of output of the inference model M.

### Example 3

Further, the inference process carried out by the inference section 12A includes, for example, inference related to future negotiation with the another company. In this case, the inference model M is, for example, a model that uses the target document d1 as input and that outputs a future negotiation scenario of the target document d1. The inference model M includes, for example, a generative model such as an autoencoder or an adversarial generation network. In this case, the generation section 13A generates the output information that includes a policy on negotiation with the another company, on the basis of output of the inference model M.

### Example of Combination of Model M and Output

### Example 1

The inference model M is trained, for example, with use of the training data d2 that includes an article sentence(s) and/or a condition(s) that is/are concluded in a form that is different from a template. The inference model M is, for example, a generative model of an adversarial network or the like. Here, input to the inference model M includes the target document d1, and output of the inference model M includes, for example, a correction candidate of the target document d1. In this case, by using the inference model M trained with use of the training data, it is possible to add or change the correction candidate.

### Example 2

Further, the inference model M is trained, for example, with use of the training data d2 that includes the number of conclusions and the timing of conclusion of a specific article sentence(s) and/or a specific condition(s). The inference model M is, for example, a generative model of an adversarial network or the like. Here, input to the inference model M includes the target document d1, and output of the inference model M includes, for the target document d1, a degree of recommendation of the article sentence(s) and/or the condition(s) and/or a degree of priority as a correction candidate. In this case, use of the inference model M trained with use of the training data makes it possible to change the degree of recommendation of each article sentence or condition and/or the degree of priority of display as a correction candidate, regardless of whether the target document d1 is identical to or different from the template.

### Example 3

Further, the inference model M is trained, for example, with use of training data d2 that includes the number of conclusions (the number of conclusions achieved) of a specific article sentence(s) and/or the number of conclusions under a condition(s). The inference model M is, for example, a discrimination model of a neural network or the like. Here, input to the inference model M includes the target document d1, and output of the inference model M includes, for example, information (conclusion probability, etc.) that indicates the possibility of conclusion of the article sentence(s) and the condition(s) of the target document d1. In this case, use of the inference model M trained with use of the training data makes it possible to display the possibility of concluding an article sentence(s) or a condition(s) in a written contract that is being reviewed, in a comparison with an article sentence(s) or a condition(s) which have a high possibility of conclusion.

### Example 4

Further, the inference model M is trained, for example, with use of training data d2 that includes the number of changes (negotiations) which were required to reach conclusion for each article. The inference model M is, for example, a discrimination model of a neural network or the like. Here, input to the inference model M includes the target document d1, and output of the inference model M includes, for example, information that indicates an article that may be subject to negotiation. In this case, use of the inference model M trained with use of the training data allows the information processing apparatus 1A to carry out a process such as issuing an alert about the article that may be subject to negotiation.

### Example 5

Further, the above-described features can be classified, for example, by the partner, by the industry, or by the company size, and acquired as the training data d2. Then, by training the inference model for each company, each industry, or the like with use of the training data, an inference result can be displayed separately for each partner, each industry, and each company size.

### Retention of Concluded Written Contract

In retention of a concluded written contract, the information processing apparatus 1A or the another apparatus may, for example, be tagged with company name, industry, standpoint, contract type, company size, a time taken to reach conclusion, the number of negotiations before arrival at the conclusion, a numerical value which quantitatively indicates a degree of difference from the template, and/or the like. Use of such an inference model M trained with use of the concluded written contract can yield, for example, in negotiation on a written contract with a specific partner, an example advantage of making it possible to display for reference the article sentence(s) and the condition(s) which are concluded with a company that is different from the partner and that is in the same industry as the partner. In addition, the use of the inference model M can yield an example advantage of, for example, making it possible to understand an approximate time to be taken to reach conclusion and to issue an alert for a contract case that is taking a longer time than normal. Further, for example, it is possible to determine a written contract that is at a higher risk than normal. Furthermore, it is possible to yield, for example, an example advantage of making it possible to quantitatively visualize a power relationship or a degree of compromise between the target company and the partner company or the industry.

### Configuration Example of Inference Model M

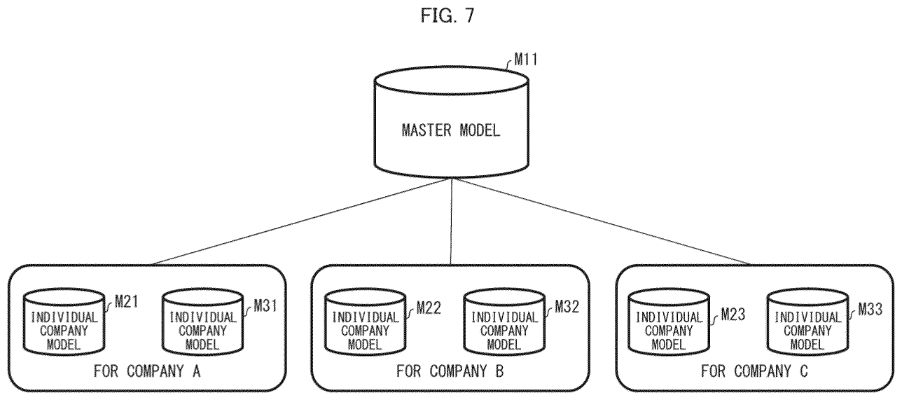

Here, the following description will discuss a configuration example of the inference model M, with reference to the drawings. FIG. 7 is a diagram illustrating a configuration example of the inference model M. Note however that a configuration, function sharing, etc. of the inference model M are not limited to the example illustrated in FIG. 7, but may be another configuration. In the example of FIG. 7, the inference model M includes a master model M11, individual company models M21 to M23, and individual company models M31 to M33. The master model M11 is an inference model common to a plurality of companies. On the other hand, the individual company models M21 to M23 and the individual company models M31 to M33 are each an inference model corresponding to one of the companies. In the example of FIG. 7, the individual company models M21 and M31 are models for a company A, the individual company models M22 and M32 are models for a company B, and the individual company models M23 and M33 are models for a company C.

### Master Model M11

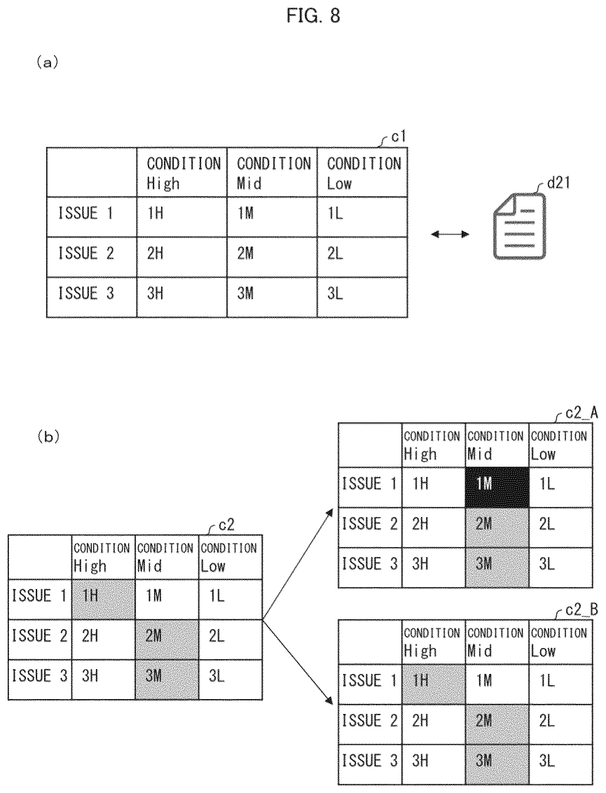

The master model M11 is an inference model that carries out detection of an issue(s) and determination of a condition(s), which are common to the plurality of companies. Input to the master model M11 includes, for example, a target document d1. Further, output of the master model M11 includes, for example, a determination result of conditions for each of a plurality of issues. (a) of FIG. 8 is a diagram illustrating a specific example of condition determination of the master model M11. In the example of FIG. 8, the master model M11 outputs a determination result c1 for conditions of each of the issues 1 to 3. Here, the determination result includes, for example, information that indicates severity of the conditions in terms of conclusion of a contract. The master model M11 is trained by accumulation of templates due to an increase in the number of contractors.

### Individual Company Models M21 to M23

The individual company models M21 to M23 are inference models that carry out unique rule determination for each company. The individual company models M21 to M23 each output, for example, a combination having a high probability of conclusion, a proposal of correction to an expression, and/or the like, depending on a contract partner and a power relationship.

Input to the individual models M21 to M23 includes, for example, a target document d1. Further, output of each of the individual company models M21 to M23 includes, for example, a determination result of conditions for each of a plurality of issues. In an example of (b) in FIG. 8, conditions c2 are initially set for each of the issues 1 to 3, and the individual company models M31 to M33 are each individually trained. Thus, respective different determination results, for example, determination results c2_A and c2_B are obtained. The individual company models M21 to M23 are each trained by accumulation of user feedback to an item pointed out.

### Individual Company Models M31 to M33

The individual company models M31 to M33 are inference models that carry out detection of special issues for each company, detection of conditions for each company, and determination of conditions for each company. Input to the individual models M31 to M33 includes, for example, a target document d1. Further, output of each of the individual company models M31 to M33 include, for example, special issues for each company and a determination result of conditions. Here, a user or a manager or the like of the information processing apparatus 1A may add an annotation.

### Examples of Output

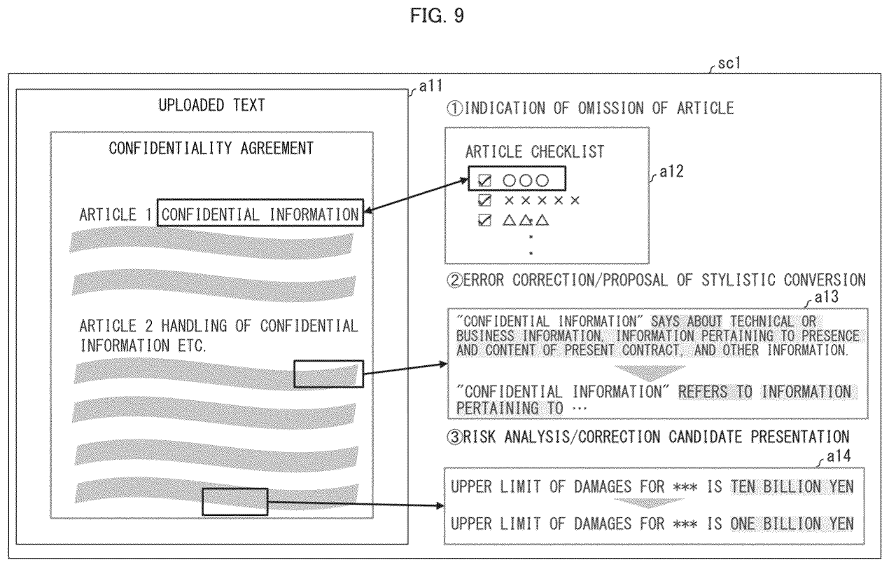

FIG. 9 is a diagram illustrating a specific example of the output information generated by the generation section 13A. In FIG. 9, a screen sc1 is a screen presented by the output information and includes display areas a11 to a14. The display area a11 displays the document d1 that has been uploaded. In the example of FIG. 9, the target document d1 includes the content of a contract for each of a plurality of articles. The display area a12 displays an indication of an omission of an article. The area displays display a13 an error correction/stylistic change proposal. The display area a14 displays risk analysis/correction candidate.

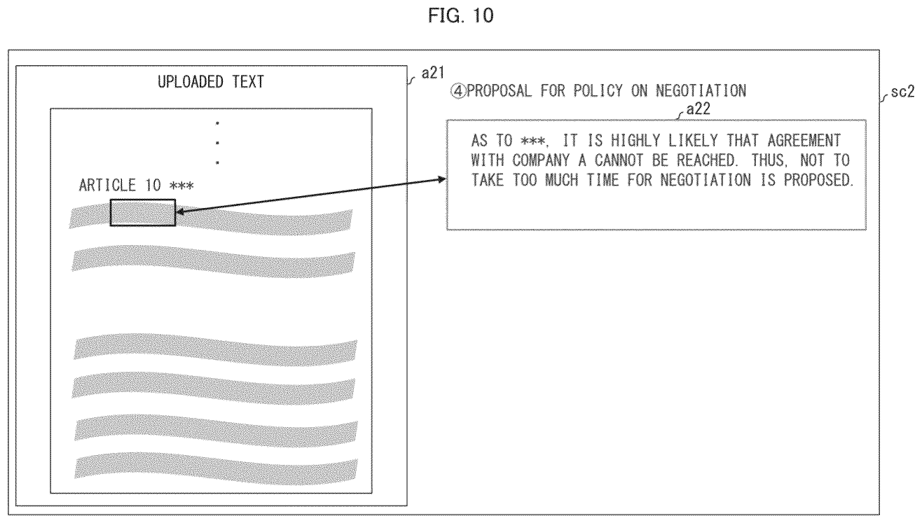

FIG. 10 is a diagram illustrating another example of the output information. In FIG. 10, a screen sc2 is a screen presented by the output information and includes display areas a21 and a22. The display area a21 displays the target document d1 that has been uploaded. The display area a22 displays a proposal of a policy on negotiation.

### Location of Storage of Data

Locations where the target document d1 and the training data d2 are stored may be locations other than the information processing apparatus 1A, for example, a server of the target company. The information processing apparatus 1A may introduce secure computing in the inference process of the inference section 12A that uses the target document d1 or in a generation process that is carried out by the generation section 13A. The information processing apparatus 1A may also introduce secure computing in an execution process (training process) of a training phase using the training data d2.

### Example Advantage of Information Processing Apparatus 1A

As described above, in the information processing apparatus 1A in accordance with the present example embodiment, the inference section 12A carries out inference on a target document with use of an inference model M trained by using a written contract template of a target company and a concluded written contract related to at least one of the target company and another company which differs from the target company. In particular, the inference model M is trained by using, as the training data, article sentences and conditions included in a concluded written contract that was prepared by using a template different from the template of the target company. Thus, the information processing apparatus 1A in accordance with the present example embodiment can yield an example advantage of making it possible to carry out more suitable inference on a draft written contract that has been prepared by using a template which is different from the template of the target company.

Further, the information processing apparatus 1A in accordance with the present example embodiment employs a configuration in which: the acquisition section 11A acquires, as the target document, at least a part of a draft written contract between the target company and the another company; and the inference model M is a model trained at least with reference to information on past negotiation between the target company and the another company. Thus, the information processing apparatus 1A in accordance with the present example embodiment can yield an example advantage of making it possible to carry out inference more suitable for the target company, in addition to the example advantage yielded by the information processing apparatus 1 in accordance with the first example embodiment.

Further, the information processing apparatus 1A in accordance with the present example embodiment employs a configuration in which the inference model M is a model trained at least with reference to information on past negotiation between the target company and one or more companies which are included in an industry to which the another company belongs. Thus, the information processing apparatus 1A in accordance with the present example embodiment can yield an example advantage of making it possible to carry out inference in consideration of the content of past negotiation, in addition to the example advantage yielded by the information processing apparatus 1 in accordance with the first example embodiment.

As described above, the information processing apparatus 1A in accordance with the present example embodiment employs a configuration in which the inference model M is a model trained at least with reference to a draft written contract that was not concluded in the past between the target company and the another company. Thus, the information processing apparatus 1A in accordance with the present example embodiment can yield an example advantage of making it possible to carry out inference in consideration of a result of past negotiation, in addition to the example advantage yielded by the information processing apparatus 1 in accordance with the first example embodiment.

Further, the information processing apparatus 1A in accordance with the present example embodiment employs a configuration in which the inference model M is a model trained at least with reference to a difference between the written contract template of the target company and the concluded written contract. Thus, the information processing apparatus 1A in accordance with the present example embodiment can yield an example advantage of making it possible to carry out inference in consideration of the content of the difference, in addition to the example advantage yielded by the information processing apparatus 1 in accordance with the first example embodiment.

Further, the information processing apparatus 1A in accordance with the present example embodiment employs a configuration in which the inference model M is a model trained at least with reference to the number of written contracts that were not concluded in the past between the target company and the another company. Thus, the information processing apparatus 1A in accordance with the present example embodiment can yield an example advantage of making it possible to carry out inference in consideration of the number of concluded contracts achieved in the past, in addition to the example advantage yielded by the information processing apparatus 1 in accordance with the first example embodiment.

Further, the information processing apparatus 1A in accordance with the present example embodiment employs a configuration in which the inference model M is a model trained at least with reference to a history of negotiation between the target company and the another company. Thus, the information processing apparatus 1A in accordance with the present example embodiment can yield an example advantage of making it possible to carry out inference in consideration of the history of past negotiation, in addition to the example advantage yielded by the information processing apparatus 1 in accordance with the first example embodiment.

Further, the information processing apparatus 1A in accordance with the present example embodiment employs a configuration in which the inference model M is a model trained at least with reference to a history of a change in a written contract in the past between the target company and the another company. Thus, the information processing apparatus 1A in accordance with the present example embodiment can yield an example advantage of making it possible to carry out inference in consideration of the change in the written contract in the past, in addition to the example advantage yielded by the information processing apparatus 1 in accordance with the first example embodiment.

Further, the information processing apparatus 1A in accordance with the present example embodiment employs a configuration in which: an inference process carried out by the inference section 12A includes inference related to correction of the target document d1; and the generation section 13A generates output information that includes a proposal related to the correction of the target document d1. Thus, the information processing apparatus 1A in accordance with the present example embodiment can yield an example advantage of making it possible to make a proposal on correction of the target document d1, in addition to the example advantage yielded by the information processing apparatus 1 in accordance with the first example embodiment.

Further, the information processing apparatus 1A in accordance with the present example embodiment employs a configuration in which: the inference process carried out by the inference section 12A includes inference related to a probability of concluding a contract with the another company; and the generation section 13A generates output information that includes the probability of concluding the contract with the another company. Thus, the information processing apparatus 1A in accordance with the present example embodiment can yield an example advantage of making it possible to present, to a user, the probability of concluding the target document d1, in addition to the example advantage yielded by the information processing apparatus 1 in accordance with the first example embodiment.

Further, the information processing apparatus 1A in accordance with the present example embodiment employs a configuration in which: the inference process carried out by the inference section 12A includes inference related to future negotiation with the another company; and the generation section 13A generates output information that includes a policy on negotiation with the another company. Thus, the information processing apparatus 1A in accordance with the present example embodiment can yield an example advantage of making it possible to present, to a user, the policy on negotiation with the another company, in addition to the example advantage yielded by the information processing apparatus 1 in accordance with the first example embodiment.

### Third Example Embodiment

The following description will discuss a third example embodiment of the present invention, with reference to drawings. Note that members having functions identical to those of the respective members described in the first and second example embodiments are given respective identical reference numerals, and a description of those members will not repeated.

### Configuration of Information Processing Apparatus 2A

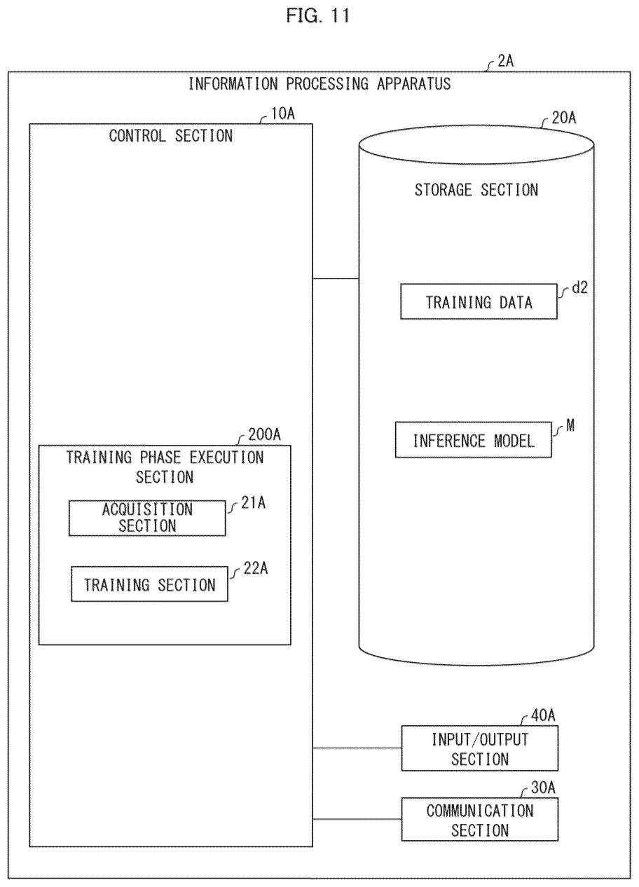

FIG. 11 is a block diagram illustrating a configuration of an information processing apparatus 2A. The information processing apparatus 2A includes a control section 10A, a storage section 20A, a communication section 30A, and an input/output section 40A. The control section 10A includes a training phase execution section 200A. The training phase execution section 200A includes an acquisition section 21A and a training section 22A. Since the acquisition section 21A and the training section 22A were described in the above second example embodiment, descriptions thereof will not be repeated here.

### Software Implementation Example

Some or all of functions of the information processing apparatus 1, 1A, 2, or 2A can be realized by hardware such as an integrated circuit (IC chip) or can be alternatively realized by software.

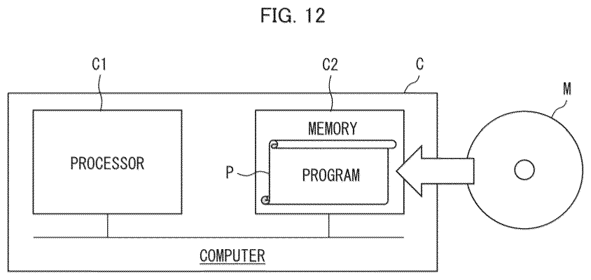

In the latter case, the information processing apparatus 1, 1A, 2, or 2A is realized by, for example, a computer that executes instructions of a program that is software realizing the foregoing functions. FIG. 12 illustrates an example of such a computer (hereinafter referred to as “computer C”). The computer C includes at least one processor C1 and at least one memory C2. The at least one memory C2 stores a program P for causing the computer C to operate as the information processing apparatus 1, 1A, 2, or 2A. In the computer C, the at least one processor C1 reads and executes the program P stored in the at least one memory C2, so that the functions of the information processing apparatus 1, 1A, 2, or 2A are realized.

Examples of the at least one processor C1 encompass a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the at least one memory C2 encompass a flash memory, a hard disk drive (HDD), a solid state drive (SSD), and a combination thereof.

Note that the computer C may further include a random access memory (RAM) in which the program P is to be loaded while being executed and in which various kinds of data are to be temporarily stored. The computer C may further include a communication interface through which data is to be transmitted and received between the computer C and at least one other apparatus. The computer C may further include an input/output interface through which input/output equipment such as a keyboard, a mouse, a display and/or a printer is/are to be connected to the computer C.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can obtain the program P via the storage medium M. The program P can alternatively be transmitted via a transmission medium. Examples of such a transmission medium encompass a communication network and a broadcast wave. The computer C can alternatively acquire the program P via the transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

The whole or part of the example embodiments disclosed above can also be described as below. Note, however, that the present invention is not limited to aspects described below.

### Supplementary Note 1

An information processing apparatus including: an acquisition means that acquires a target document which is at least a part of a target draft written contract; an inference means that carries out inference related to the target document, with use of an inference model trained by using a written contract template of a target company and a concluded written contract related to at least one of the target company and another company which differs from the target company; and a generation means that generates output information obtained with reference to an inference result obtained by the inference means.

### Supplementary Note 2

The information processing apparatus according to supplementary note 1, wherein: the acquisition means acquires, as the target document, at least a part of a draft written contract between the target company and the another company; and the inference model is a model trained at least with reference to information on past negotiation between the target company and the another company.

### Supplementary Note 3

The information processing apparatus according to supplementary note 2, wherein the inference model is a model trained at least with reference to information on past negotiation between the target company and one or more companies which are included in an industry to which the another company belongs.

### Supplementary Note 4

The information processing apparatus according to supplementary note 2 or 3, wherein the inference model is a model trained at least with reference to a draft written contract that was not concluded in the past between the target company and the another company.

### Supplementary Note 5

The information processing apparatus according to claim 2 or 3, wherein the inference model is a model trained at least with reference to a difference between the written contract template of the target company and the concluded written contract.

### Supplementary Note 6

The information processing apparatus according to any one of supplementary notes 2 to 5, wherein the inference model is a model trained at least with reference to the number of written contracts that were concluded in the past between the target company and the another company.

### Supplementary Note 7

The information processing apparatus according to any one of supplementary notes 2 to 6, wherein the inference model is a model trained at least with reference to a history of negotiation between the target company and the another company.

### Supplementary Note 8

The information processing apparatus according to any one of supplementary notes 2 to 7, wherein the inference model is a model trained at least with reference to a history of a change in a written contract in the past between the target company and the another company.

### Supplementary Note 9

The information processing apparatus according to any one of supplementary notes 1 to 8, wherein: an inference process carried out by the inference means includes inference related to correction of the target document; and the generation means generates output information that includes a proposal related to the correction of the target document.

### Supplementary Note 10

The information processing apparatus according to any one of supplementary notes 1 to 9, wherein: the inference process carried out by the inference means includes inference related to a probability of concluding a contract with the another company; and the generation means generates output information that includes the probability of concluding the contract with the another company.

### Supplementary Note 11

The information processing apparatus according to any one of supplementary notes 1 to 10, wherein: the inference process carried out by the inference means includes inference related to future negotiation with the another company; and the generation means generates output information that includes a policy on negotiation with the another company.

### Supplementary Note 12

An information processing apparatus including: an acquisition means that acquires a written contract template of a target company and a concluded written contract related to at least one of the target company and another company which differs from the target company; and a training means that trains, with reference to information acquired by the acquisition means, an inference model that carries out inference on a target document.

### Supplementary Note 13

An information processing method including: acquiring, by at least one processor, a target document which is at least a part of a target draft written contract; carrying out, by the at least one processor, inference related to the target document, with use of an inference model trained by using a written contract template of a target company and a concluded written contract related to at least one of the target company and another company which differs from the target company; and generating, by the at least one processor, output information obtained with reference to an inference result obtained by the inference.

### Supplementary Note 14

An information processing method including: acquiring, by at least one processor, a written contract template of a target company and a concluded written contract related to at least one of the target company and another company which differs from the target company; and training, by the at least one processor, with reference to the written contract template and the concluded written contract, an inference model that carries out inference on a target document.

### Supplementary Note 15

An information processing program for causing a computer to carry out: an acquisition process for acquiring a target document which is at least a part of a target draft written contract; an inference process for carrying out inference related to the target document, with use of an inference model trained by using a written contract template of a target company and a concluded written contract related to at least one of the target company and another company which differs from the target company; and a generation process for generating output information obtained with reference to an inference result obtained by the inference process.

### Supplementary Note 16

An information processing program for causing a computer to carry out: an acquisition process for acquiring a written contract template of a target company and a concluded written contract related to at least one of the target company and another company which differs from the target company; and a training process for training, with reference to information acquired in the acquisition process, an inference model that carries out inference on a target document.

### Additional Remark 3

The whole or part of the example embodiments disclosed above further can also be expressed as follows.

An information processing apparatus including at least one processor, the processor carrying out: an acquisition process for acquiring a target document which is at least a part of a target draft written contract; an inference process for carrying out inference related to the target document, with use of an inference model trained by using a written contract template of a target company and a concluded written contract related to at least one of the target company and another company which differs from the target company; and a generation process for generating output information obtained with reference to an inference result obtained by the inference process.

Note that this information processing apparatus can further include a memory, and in this memory, a program for causing the processor to carry out the acquisition process, the inference process, and the generation process can be stored. The program may be stored in a non-transitory tangible computer-readable storage medium.

In addition, the whole or part of the example embodiments disclosed above further can also be expressed as follows.

An information processing apparatus including at least one processor, the processor carrying out: an acquisition process for acquiring a written contract template of a target company and a concluded written contract related to at least one of the target company and another company which differs from the target company; and a training process for training, with reference to information acquired in the acquisition process, an inference model that carries out inference on a target document.

Note that this information processing apparatus can further include a memory, and in this memory, a program for causing the processor to carry out the acquisition process and the training process can be stored. The program may be stored in a non-transitory tangible computer-readable storage medium.

The above description has discussed the present invention with reference to the above example embodiments etc. However, the present invention is not limited to the above-described example embodiments. Various modifications which can be understood by a person skilled in the art within the scope of the present invention can be made to the configurations and details of the present invention. At least one or more functions of the information processing apparatus 1, 1A, 2 or 2A described above may be executed in a plurality of different information processing apparatuses that are installed at and connected to any locations on a network, that is, may be executed in so-called cloud computing.

### Reference Signs List

1, 1A, 2, 2A information processing apparatus
11, 11A, 21, 21A acquisition section
12, 12A inference section
13, 13A generation section
22, 22A learning section
S1, S1A, S2 information processing method

What is claimed is:

1. An information processing apparatus comprising at least one processor, the at least one processer carrying out:
an acquisition process that acquires a target document which is at least a part of a target draft written contract;
an inference process that carries out inference related to the target document, with use of an inference model trained by using a written contract template of a target company and a concluded written contract related to at least one of the target company and another company which differs from the target company; and
a generation process that generates output information obtained with reference to an inference result obtained by the inference process.

2. The information processing apparatus according to claim 1, wherein:
in the acquisition process, the at least one processor acquires, as the target document, at least a part of a draft written contract between the target company and the another company; and
the inference model is a model trained at least with reference to information on past negotiation between the target company and the another company.

3. The information processing apparatus according to claim 2, wherein
the inference model is a model trained at least with reference to information on past negotiation between the target company and one or more companies which are included in an industry to which the another company belongs.

4. The information processing apparatus according to claim 2, wherein
the inference model is a model trained at least with reference to a draft written contract that was not concluded in the past between the target company and the another company.

5. The information processing apparatus according to claim 2, wherein
the inference model is a model trained at least with reference to a difference between the written contract template of the target company and the concluded written contract.

6. The information processing apparatus according to claim 2, wherein
the inference model is a model trained at least with reference to the number of written contracts that were concluded in the past between the target company and the another company.

7. The information processing apparatus according to claim 2, wherein
the inference model is a model trained at least with reference to a history of negotiation between the target company and the another company.

8. The information processing apparatus according to claim 2, wherein
the inference model is a model trained at least with reference to a history of a change in a written contract in the past between the target company and the another company.

9. The information processing apparatus according to claim 1, wherein:
the inference process includes inference related to correction of the target document; and
in the generation process, the at least one processor generates output information that includes a proposal related to the correction of the target document.

10. The information processing apparatus according to claim 1, wherein:
the inference process includes inference related to a probability of concluding a contract with the another company; and
in the generation process, the at least one processor generates output information that includes the probability of concluding the contract with the another company.

11. The information processing apparatus according to claim 1, wherein:
the inference process includes inference related to future negotiation with the another company; and
in the generation process, the at least one processor generates output information that includes a policy on negotiation with the another company.

12. An information processing apparatus comprising at least one processor, the at least one processer carrying out:
an acquisition process that acquires a written contract template of a target company and a concluded written contract related to at least one of the target company and another company which differs from the target company; and
a training process that trains, with reference to information acquired by the acquisition process, an inference model that carries out inference on a target document.

13. An information processing method comprising:
acquiring, by at least one processor, a target document which is at least a part of a target draft written contract;
carrying out, by the at least one processor, inference related to the target document, with use of an inference model trained by using a written contract template of a target company and a concluded written contract related to at least one of the target company and another company which differs from the target company; and
generating, by the at least one processor, output information obtained with reference to an inference result obtained by the inference.

14. (canceled)

15. A computer-readable non-transitory storage medium storing an information processing program for causing a computer to function as the information processing apparatus according to claim 1, the program for causing the computer to carry out the acquisition process, the inference process, and the generation process.

16. A computer-readable non-transitory storage medium storing an information processing program for causing a computer to function as the information processing apparatus according to claim 12, the program for causing the computer to carry out the acquisition process and the training process.
